(19) United States
(12) Patent Application Publication
(10) Pub. No.: US 2008/0163332 A1
(43) Pub. Date: Jul. 3, 2008

(54) Selective secure database communications

(76) Inventor: Richard Hanson, Cerritos, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/646,827

(22) Filed: Dec. 28, 2006

(51) Int. Cl. H04L 9/32

(52) U.S. Cl. 726/1

(57) ABSTRACT

Techniques for selective secure database communications are presented. Communications directed to a database are inspected to determine the originators and the origins for those communications. Policy is evaluated in response to the originators and the origins of the communications. When dictated by the policy, the communications are redirected to an encryption service to be encrypted before being forwarded to the database for subsequent processing.

### FIELD

The invention relates generally to database technology and more particularly to techniques for selective security associated with database communications.

### BACKGROUND

Enterprises are increasingly capturing, storing, and mining a plethora of information related to communications with their customers. Often this information is stored and indexed within databases. Once the information is indexed, queries are developed on an as-needed basis to mine the information from the database for a variety of organizational goals: such as planning, analytics, reporting, etc.

These databases include often includes a mixture of public information and private/confidential information. The database is also likely accessible from within a secure environment and also over a wide are network (WAN), such at the Internet, which can expose the database and its information to potential security risks. Consequently, an enterprise may devise a variety of security mechanisms to ensure that confidential information is not compromised over the Internet or the World-Wide Web (WWW), such as authentication techniques, use of Secure Sockets Layer (SSL) communications, etc.

Many times the enterprise relies on the user to determine whether security is needed. However, this is not a desirable approach because it assumes that the user is legitimate, honest, and competent enough to know when security is needed; and often this assumption can be prove to be wrong and thus detrimental to the enterprise.

Thus, it can be seen that improved mechanisms for selective and secure database communication techniques are needed.

### SUMMARY

In various embodiments, techniques for selective secure database communications are presented. According to an embodiment, a method for selectively enforcing encryption on database communications is provided. A user is identified who is attempting to communicate with a database. In response to this a proper policy is acquired and the user is directed to an encryption mechanism for use when communicating with the database in response to directives associated with that policy.

### BRIEF DESCRIPTION OF THE DRAWINGS

FIG. 1 is a diagram of a method for selectively enforcing encryption on database communications, according to an example embodiment.

FIG. 2 is a diagram of another method for selectively enforcing encryption on database communications, according to an example embodiment.

FIG. 3 is a diagram of a selective database encryption system, according to an example embodiment.

### DETAILED DESCRIPTION

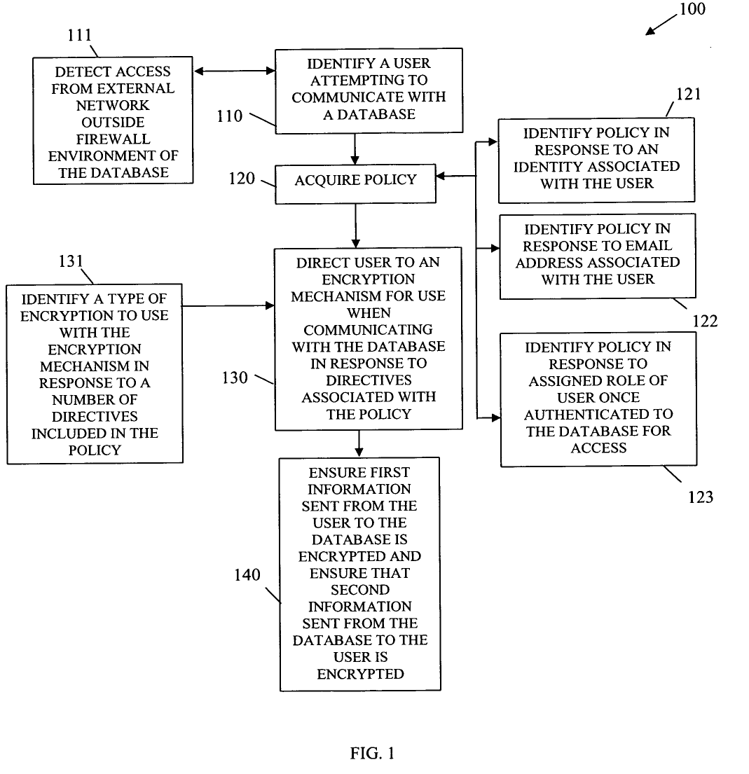

FIG. 1 is a diagram of a method 100 for selectively enforcing encryption on database communications. The method 100 (hereinafter “encryption service”) is implemented in a machine-accessible or computer-readable medium as instructions that when executed by a machine (processing device) performs the processing depicted in FIG. 1. Moreover, the encryption service is optionally accessible over a network. The network may be wired, wireless, or a combination of wired and wireless.

A “database” as used herein is a relational database, or a collection of databases organized as a data warehouse. According to an embodiment, the database is a Teradata® product or service distributed by NCR Corporation of Dayton, Ohio.

The database includes a variety of enterprise information organized in tables. One type of information is referred to as an “entity.” An entity is something that can be uniquely identified (e.g., a customer account, a customer name, a household name, a logical grouping of certain types of customers, etc.).

Any “encryption” technique may be used herein. The encryption may be symmetrical or asymmetrical. Additionally, the encryption may be custom defined based on some key or hash value or may use public-private key pairs. Any encryption service and technique maybe used with the teachings presented herein and below.

It is within this context that the processing associated with the encryption service is now described in detail with reference to the FIG. 1.

At 110, encryption service identifies a user attempting to communicate with a database. The user may be attempting to log into and authenticate to the database. Alternatively, the user may have already been authenticated to access the database and may be sending communications to the database during that authenticated communication session. So, the encryption service may be implemented as part of the login or authentication procedure that a user goes through to access the database or it may be used independent of the login process.

In one case, the encryption service is implemented as a gateway or proxy service. For example, the encryption service may be implemented as a reverse proxy that is configured to handle Internet or WWW access requests that originate from outside a firewall environment. The user may not even be aware of the existence of the encryption service; rather, the encryption service detects external network requests directed to the database and intercepts those and uniquely processes those requests in the manners discussed more completely below.

Thus, according to an embodiment, at 111, the encryption service may detect access attempts from external network feeds or connections, which are located outside a firewall environment that is associated with the database.

At 120, the encryption service acquires policy to assist in helping it further process the intercepted communications that are being directed from the user to the database. The appropriate policy may be resolved in a variety of manners.

For example, at 121, the encryption service may identify the policy in response to an Internet Protocol (IP) address associated with the user. In other words, a portion of the IP address may indicate that it is originating from an external domain. This can be done in a variety of ways. The IP address may be hard coded in a lookup table that alerts the encryption service to a specific policy or a portion of the IP address (domain name) may be hard coded in a lookup table. In another situation, the if the IP address or domain name associated with the IP address is not known via a lookup table then a generic policy is acquired. It may also be the case, that if a domain certificate is not known or not validated for a given IP domain associated with the IP address then a generic policy is acquired.

In another case, at 122, the encryption service may identify the policy in response to an identity associated with the user. That is, the user authenticates to a particular identity. So, the user may be using an identity associated with a non recognized account for that user and in response thereto a generic policy is identified and acquired. Again, the specific identity may be hard coded or may be unknown and in either situation, the encryption service associates those conditions with a specific or generic policy that is to be used to handle the given conditions.

In still another situation, at 123, the encryption service may identify policy in response to an assigned role of the user once the user is authenticated to the database for access. Here, the user may log in and authenticate to the database using a specific identifier and authentication secret. Policy then drives the role that the user is assigned for accessing resources of the database, such as administrator, analyst, management, etc. The assigned role is associated with specific access rights or limitations. The assigned role may also be used by the encryption service to resolve a specific policy that is to be applied with respect to encryption. In some cases, the user may be assigned a set of roles and may switch back and forth between specific available and assignable roles. Some roles assumed may, via policy, necessitate a particular type of encryption; whereas other roles assumed may, via a different policy, permit no encryption. Dynamic switching from encryption to no encryption may be achieved via policies assigned for any assumed role.

At 130, the encryption service directs the user to an encryption mechanism for use when communicating with the database in response to directives associated with the policy. So, the policy may identify a specific encryption technique or encryption service that the user is to interact with when sending communications to the database. The database then uses the proper corresponding decryption mechanisms or techniques to decrypt and process the user communications. Thus, a Quality of Protection value may be dynamically associated with the user via a policy. The Quality of Protection value may dictate the key size or type for a given encryption mechanism and/or a specific encryption algorithm or service.

Thus, in an embodiment, at 131, the encryption service may identify a type of encryption to use with the encryption mechanism in response to logic, conditions, or directives included in the policy. In some cases, the policy may be used to acquire a specific encryption key to be used for the encryption. The user may independently know how to acquire the key or may have the key in the user's possession already. Alternatively, by prior arrangement or agreement the user and the database may know the encryption that is to be used for communicating with one another.

According to an embodiment, at 132, the encryption service may actually be the resource that ensures any first information that is sent from the user to the database is encrypted and that also ensures any second information (responses) sent from the database to the user is also encrypted. In other words, it may be that the encryption service itself acts as the go between or intermediary for the user and the database.

It is noted that the database may be unaware of the encryption entirely. In other words, the encryption service or other third-party services may encrypt and decrypt communications being sent from and being received by the database. In this manner, no changes or alterations have to be made to the database and its interfaces to ensure that selective encryption is being used in response to policy. The database may just believe that an authenticated user is requesting access and may supply responses. The encryption service or another third-party service enlisted to assist then ensures communications received from a user are decrypted before the database processes them and ensures that responses sent from the database are encrypted before being sent to the user.

It can now be seen how selective database communications may be encrypted for added security based on policy. So, the user does not decide whether encryption is needed; rather, policy drives whether encryption is to be used when communicating with the database. This provides greater flexibility and increased database security for a variety of situations, such as when a user is accessing the database remotely and potentially over insecure network environments or connections. However, the techniques may also be useful within a secure environment (wholly within a firewall environment) to make more important communications even more secure.

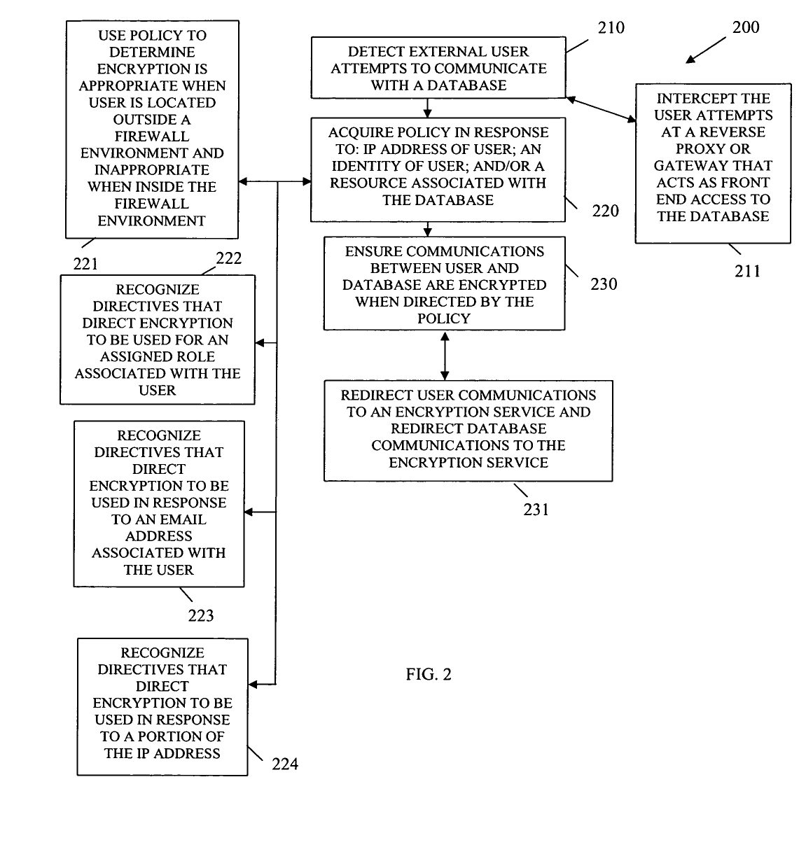

FIG. 2 is a diagram of another method 200 for selectively enforcing encryption on database communications. The method 200 (hereinafter “selective encryption service”) is implemented in a machine-accessible and readable medium as instructions that when executed by a machine performs the processing reflected in FIG. 2. The selective encryption service may also be accessible over a network. The network may be wired, wireless, or a combination of wired and wireless. The selective encryption service presents another different perspective of and enhanced view of the encryption service represented by the method 100 of the FIG. 1.

At 210, the selective encryption service detects external user attempts to communicate with a database. Again, this detection can occur in a variety of locations, some of which may be integrated within Application Programming Interfaces (API's) of the database and some of which serve as a front end to the database and which the database is unaware of. For example, at 211, the selective encryption service may intercept the user attempts to access the database at a reverse proxy or gateway service, which acts as a front end access point to the database.

The selective encryption service may also be implemented as part of or as being callable from the login service associated with the database. Thus, when a user attempts to initially log into the database and is assigned access rights, the selective encryption service is called or processed to perform the features discussed herein and below.

At 220, the selective encryption service acquires policy or identifies a specific policy that is applicable to the user with respect to communicating with the database. A variety of information may be used to resolve the policy that is to be used. For example, an IP address of the user may be used to locate an applicable policy. An assumed identity that the user authenticated to when attempting to log into the database may also be used to locate the policy to enforce. Additionally, a specific resource (e.g., specific operation or table of the database, etc.) that the user is attempting to access or communicate with may be associated with its own specific policy. So, the policy may be specific to the user or may be specific to a resource associated with the database.

The policy includes a variety of directives, logic, or conditions that the selective encryption service enforces against the user attempts to communicate with the database. For example, at 221, the policy may be used to determine that the communications are to be encrypted when the user is accessing the database from outside a firewall environment that is associated with the database. The policy may also be used to determine that encryption is inappropriate or not to be used when the user is accessing the database from within the firewall environment.

According to another case, at 222, the selective encryption service may recognize that the policy directs that encryption is to be enforced when the user has a particular assigned access role, such as administrator, management, etc. So, the policy may be specific to where the user is located when attempting to access the database and/or may be specific to what access role the user assumes or is assigned when attempting to access the database.

In yet another situation, at 223, the selective encryption service may recognize that the policy directs encryption to be used in response to a particular email address that the user has when the user attempted to access the database. The email address may be viewed as one of many identifiers that the user may assume; other identifiers may include employee number, last name, etc. Thus, the policy may dictate that the database communications are to be selectively encrypted in response to a particular identifier that the user has when attempting to access the database, such as a particular email address.

In a similar circumstance, at 224, the selective encryption service may recognize pursuant to the policy that encryption is to be used in response to at least some portion of the IP address that the user has when the user attempts to access the database. Thus, a particular domain being used can be detected and if it is recognized or if it is unrecognized a particular or generic policy may be used that directs encryption to take place.

At 230, the selective encryption service is used to ensure that communications occurring between the user and the database are encrypted when directed by the policy. Again, the selective encryption service may perform the encryption between the two resources (database and user) or the selective encryption service may enlist other third-party services to ensure that encryption is being used. In some situations, the selective encryption service may just police communications to ensure that encryption is being used and if not the communications may be removed and not forwarded to the proper party for subsequent processing. This may occur when the user and the database are encrypting the communications themselves without any additional third-party service or without any additional direct intervention of the selective encryption service.

According to an embodiment, at 231, the selective encryption service may redirect user communications to an encryption service (third-party service) when the user sends communications to the database. Similarly, the selective encryption service may redirect responses received from the database to the encryption service before the responses are sent to the user. In this manner, the user and the database may be entirely unaware of the encryption that is taking place. Other local services to the database and to the user (on the client side) may be used to transparently decrypt the communications. A variety of proxy configurations may be used to achieve this scenario, such as a transparent proxy and a reverse proxy arrangement. In some cases, if the user's client is aware of the proxy then a forward proxy architecture may be used.

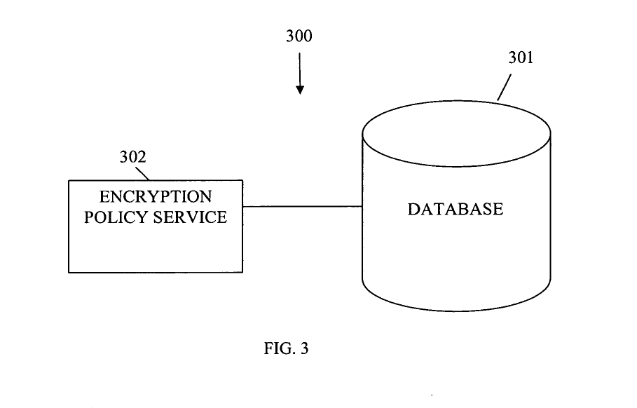

FIG. 3 is a diagram of a selective database encryption system 300, according to an example embodiment. The selective database encryption system 300 is implemented in a machine-accessible and readable medium and is operational over a network. The network may be wired, wireless, or a combination of wired and wireless. In an embodiment, portions of the selective database encryption system 300 implements, among other things the encryption service and the selective encryption service represented by the methods 100 and 200 of the FIGS. 1 and 2, respectively.

The selective database encryption system 300 includes a data store 301 and an encryption policy service 302. Each of these and their interactions with one another will now be discussed in turn.

The database 301 may be a relational database or a collection of relational databases organized and cooperating as a data warehouse. The database 301 resides within and is accessible from a machine-readable medium. According to an embodiment, the database 301 is a Teradata® product distributed by NCR, Corporation of Dayton, Ohio.

The database 301 houses a variety of tables for enterprise data. Each table may have its own schema definition that defines the fields and other aspects of the table and the data that the table may house. An Application Programming Interface (API) may be used to access and perform operations on the database 301. One aspect of the API includes a database query language, such as SQL. The database 301 interacts with the custom measure calculation service 302 and, optionally, a GUI tool 303.

The encryption policy service 302 is also implemented in a machine-accessible medium and is processed on a machine. The encryption policy service 302 is to inspect communications from users, which are directed to the database 301, to determine whether the communications are to be encrypted or are to not be encrypted.

According to an embodiment, the encryption policy service 302 determines whether encryption is needed or not in response to policy. The policy is associated with the user or some aspect of the user's attributes or user's communication mechanism. The policy may also be associated with the database 301 or some specific resource of the database 301 that the user is attempting to access or communicate with. The policy drives under what circumstances and conditions the encryption policy service 302 is to enforce encryption in the communications that occur between the database 301 and the user. The policy itself may be indexed and accessible from the database 301 via a policy store table.

According to an embodiment, the encryption policy service 302 may be implemented to operate on a machine as a reverse proxy service associated with a front end of the database 301. The reverse proxy service handles external network requests that attempt to access the database 301 from outside a firewall environment.

It is also noted that the selective database encryption service 302 may operate as a front end service to the database 301 to handle selective encryption of communications between users and the database 301 that originate from within a firewall environment and from outside the firewall environment. In other words, selective encryption does not have to be exclusively tied to external users attempting to access the database 301; rather, in some cases, policy may dictate that certain types of information or resources associated with the database 301 require encryption even within a secure firewall environment. This may occur when sensitive information is being exposed on the secure network and there is a desire to enhance security by using encryption.

It may also be the case, that the encryption policy service 302 may direct communications, which are to be encrypted pursuant to policy, to an encryption service. The encryption service then encrypts the communications before the communications are sent to the database. Similarly, the encryption policy service may direct response received from the database to an encryption service for encryption before being sent to the users.

One now appreciates how policy may be used to selective drive encryption of database communications. This can selectively apply encryption in situations where policy dictates encryption is appropriate or more secure. The user does not drive this determination; rather, the enterprise drives this determination via policy administered and applied in the manners described herein.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
identifying a user attempting to communicate with a database;
acquiring policy; and
directing the user to an encryption mechanism for use when communicating with the database in response to directives associated with the policy.

2. The method of claim 1, wherein acquiring policy further includes identifying the policy in response to an Internet Protocol (IP) address associated with the user.

3. The method of claim 1, wherein acquiring policy further includes identifying the policy in response to an authenticated identity associated with the user.

4. The method of claim 1, wherein acquiring policy further includes identifying the policy in response to an assigned role associated with the user after the user authenticates to the database.

5. The method of claim 1, wherein directing further includes identifying a type of encryption to use with the encryption mechanism in response to a number of the directives included in the policy.

6. The method of claim 1, wherein identifying further includes detecting the user attempting to access the database from an external network connection outside a firewall environment associated with the database.

7. The method of claim 1 further comprising:
ensuring first information sent from the user to the database is encrypted; and
ensuring second information sent from the database to the user is also encrypted.

8. A method, comprising:
detecting external user attempts to communicate with a database;
acquiring policy in response to one or more of the following: an identity associated with the user, an Internet Protocol (IP) address being used by the user, and a resource associated with the database; and
ensuring communications between the user and the database are encrypted when directed by the policy.

9. The method of claim 8, wherein detecting further includes, intercepting the user attempts at a reverse proxy service or gateway that acts as a front end access to the database for external access requests to the database.

10. The method of claim 8, wherein acquiring further includes using the policy to determine that encryption is to be used for the user when the user is located outside a firewall environment of the database and that encryption is unnecessary when the user is located inside the firewall environment of the database.

11. The method of claim 8, wherein acquiring further includes recognizing directives within the policy that direct encryption to be used in response to an assigned access role associated with the user when the user authenticates to the database.

12. The method of claim 8, wherein acquiring further includes recognizing directives within the policy that direct encryption to be used in response to an electronic mail (email) address associated with the user.

13. The method of claim 8, wherein acquiring further includes recognizing directives within the policy that direct encryption to be used in response to a portion of the IP address.

14. The method of claim 8, wherein ensuring further includes redirecting user communications to an encryption service before forwarding the user communications to the database and redirecting database communications to the encryption service before forwarding to the database communications to the user.

15. A system comprising:
a database accessible within a machine-readable medium; and
a encryption policy service to be processed by a machine within the machine-readable medium, wherein the encryption policy service is to inspect communications from users directed to the database and is to determine whether the communications are to be encrypted or not encrypted on behalf of the database.

16. The system of claim 15, wherein the encryption policy service is to determine whether to encrypt or not encrypt in response to policy, and wherein the policy is associated with the users or the database.

17. The system of claim 15, wherein the encryption policy service is operated on the machine as a reverse proxy of the database to handle external network requests that attempt to access the database outside a firewall environment.

18. The system of claim 15, wherein the encryption policy service is operated as a front-end service of the database to handle both internal and external requests that attempt to access the database from within a firewall environment and from outside the firewall environment.

19. The system of claim 15, wherein the encryption policy service is to direct the communications, which are to use encryption, to an encryption service to be encrypted before being sent to the database.

20. The system of claim 19, wherein the encryption policy service is to direct responses from the database to the encryption service before being sent to the users.
